(19) United States
(12) Patent Application Publication
(10) Pub. No.: US 2026/0030808 A1
(43) Pub. Date: Jan. 29, 2026

(54) METHOD AND COMPUTER SYSTEM FOR IMAGE PIXELIZATION

(71) Applicant: MediaTek Singapore Pte. Ltd., Singapore (SG)

(72) Inventor: Yang LIU, Shenzhen (CN)

(21) Appl. No.: 18/828,203

(22) Filed: Sep. 9, 2024

(30) Foreign Application Priority Data
Jul. 26, 2024 (CN) 202411017562.7

(51) Int. Cl. G06T 11/60; G06T 7/62; G06V 10/25

(52) U.S. Cl. CPC G06T 11/60; G06T 7/62; G06V 10/25

(57) ABSTRACT

Provided is a pixelization method. The method involves generating a mosaic mapping table. The mosaic mapping table includes multiple mapping entries, each mapping entry recording an output pixel coordinate of a pixelated image and an input pixel coordinate of an input image. The method further involves using the mosaic mapping table to transform the input image into the pixelated image. The output pixel value corresponding to the output pixel coordinate in each mapping entry is set to the input pixel value corresponding to the input pixel coordinate in that mapping entry.

### CROSS REFERENCE TO RELATED APPLICATIONS

This Application claims priority of China Patent Application No. 202411017562.7, filed on Jul. 26, 2024, the entirety of which is incorporated by reference herein

### BACKGROUND OF THE INVENTION

### Field of the Invention

The present invention relates to image processing, and, in particular, to a method and computer system for image pixelization.

### Description of the Related Art

Currently, image pixelization (i.e., generating mosaic effects) are implemented using GPU and/or CPU through software. In GPU implementation, a pixel block size is selected, and shaders or kernel functions are written using image APIs or GPU programming frameworks. Each pixel block (or called “mosaic tile”) is processed in parallel on the GPU, calculating the average color value and updating the color of all pixels within the block. In CPU implementation, a pixel block size is selected, for example, each block containing 8×8 pixels. Each block in the image is traversed, and the average color value of all pixels within each block is calculated. All pixels within each block are then set to this average color value. This process is repeated until the entire image is processed. However, the above methods consume considerable GPU and/or CPU resources.

In view of the above technical challenges, there is a need for a pixelization solution to relieve the workloads of CPU and GPU.

### BRIEF SUMMARY OF THE INVENTION

An embodiment of the present disclosure provides a method for image pixelization. The method is executed by a processing unit of a computer system. The method includes a first operation and a second operation. The first operation involves generating a mosaic mapping table. The mosaic mapping table includes multiple mapping entries, each mapping entry recording an output pixel coordinate of a pixelated image and an input pixel coordinate of an input image. The input pixel coordinate falls within a mosaic tile that includes the mapping entry. The second operation involves using the mosaic mapping table to transform the input image into the pixelated image. The output pixel value corresponding to the output pixel coordinate recorded in each mapping entry is set to the input pixel value corresponding to the input pixel coordinate recorded in that mapping entry.

An embodiment of the present disclosure provides a computer system for image pixelization. The computer system includes a storage unit and a processing unit. The storage unit stores a program. The processing unit loads the program from the storage unit to perform the first operation and the second operation.

In an embodiment, the first operation generates the mosaic mapping table by initializing a mapping table, obtaining an ROI parameter that defines an ROI (region of interest) in the input image to be pixelated, and performing a remapping operation on the input pixel coordinate and the output pixel coordinate recorded in each initialized mapping entry within the ROI. Each initialized mapping entry of the initialized mapping table records the output pixel coordinate, and the input pixel coordinate that is the same as the input pixel coordinate. The remapping operation is performed on a mosaic tile-by-tile basis to generate the mosaic mapping table, and involves changing at least a portion of the input pixel coordinates recorded in each initialized mapping entry within each mosaic tile.

In an embodiment, the first operation further involves obtaining a mosaic type parameter that defines a mosaic type of the pixelated image. The remapping operation is performed based on the mosaic type parameter to generate the mosaic mapping table that is used in the second operation to transform the input image into the pixelated image with the mosaic type.

In an embodiment, options of the mosaic type include a uniform-tile mosaic. In response to the mosaic type parameter being set to the uniform-tile mosaic, the remapping operation involves unifying the input pixel coordinates recorded in the initialized mapping entries within each mosaic tile to a specific pixel coordinate within that mosaic tile.

In another embodiment, options of the mosaic type include a randomized-pixel mosaic. In response to the mosaic type parameter being set to the randomized-pixel mosaic, the remapping operation involves randomly shuffling the input pixel coordinates recorded in the initialized mapping entries within each mosaic tile.

In yet another embodiment, options of the mosaic type include a chessboard mosaic. In response to the mosaic type parameter being set to the chessboard mosaic, the remapping operation includes unifying the input pixel coordinates recorded in the initialized mapping entries on borders of each mosaic tile to a specific pixel coordinate within that mosaic tile.

In an embodiment, the first operation further involves obtaining a mosaic level parameter that defines a tile size of the mosaic tiles used in the remapping operation.

In an embodiment, the ROI parameter includes a location parameter, a size parameter, and a shape parameter, defining location, size, and shape of the ROI, respectively.

In an embodiment, while the second operation is transforming a first frame of an input image sequence, the first operation is generating the mosaic mapping table to be used for transforming a second frame subsequent to the first frame of the input image sequence.

In an embodiment, the processing unit includes a main processor and a pixelization circuit. Additionally, the first operation is performed by the main processor, and the second operation is performed by the pixelization circuit.

The pixelization solution proposed in the present disclosure addresses the challenges of prior art from several aspects as described below. Firstly, in embodiments of the present disclosure, the realization of the mosaic effect is based on the mapping relationship between the pixel coordinates of the input image and the pixelated image, eliminating the need to calculate the average color value for each mosaic tile. Secondly, variations in the mosaic effects can be achieved by simply manipulating the mosaic mapping table to change the recorded pixel coordinates, without the need to compute pixel values for the R (red), G (green), and B (blue) channels. Furthermore, the transformation from the input image to the pixelated image can be performed by dedicated circuitry, without involving the GPU or CPU. This not only saves GPU and CPU resources but also leverages the real-time or near-real-time performance of dedicated circuits. In summary, the pixelization solution proposed in the present disclosure can achieve mosaic effects efficiently in real-time, reducing the burden on the CPU or GPU and freeing up computational resources for other tasks.

### BRIEF DESCRIPTION OF THE DRAWINGS

The present invention can be more fully understood by reading the subsequent detailed description and examples with references made to the accompanying drawings, wherein:

FIG. 1 is a flow diagram of a method for image pixelization, according to an embodiment of the present disclosure;

FIG. 2 shows an exemplary mosaic mapping table, according to an embodiment of the present disclosure;

FIG. 3 is a block diagram of a computer system for image pixelization, according to an embodiment of the present disclosure;

FIG. 4 is a block diagram of a computer system for image pixelization, according to another embodiment of the present disclosure;

FIG. 5 is a flow diagram of detailed steps of the first operation, according to an embodiment of the present disclosure;

FIG. 6 showcases a comparison between an exemplary input image and its corresponding pixelated image, according to an embodiment of the present disclosure;

FIG. 7 showcases an exemplary pixelated ROI with the uniform-tile mosaic type, according to an embodiment of the present disclosure;

FIG. 8 showcases an exemplary pixelated ROI with the randomized-pixel mosaic type, according to another embodiment of the present disclosure;

FIG. 9 showcases an exemplary pixelated ROI with the chessboard mosaic type, according to yet another embodiment of the present disclosure;

FIG. 10 showcases a comparison between an exemplary pixelated ROI and another exemplary pixelated ROI, with different tile size settings;

FIG. 11 showcases an exemplary pixelated ROI, in which the pixel values within each mosaic tile have undergone rotation and reflection.

### DETAILED DESCRIPTION OF THE INVENTION

The following description is made for the purpose of illustrating the general principles of the invention and should not be taken in a limiting sense. The scope of the invention is best determined by reference to the appended claims.

In each of the following embodiments, the same reference numbers represent identical or similar elements or components.

It must be understood that the terms “including” and “comprising” are used in the specification to indicate the existence of specific technical features, numerical values, method steps, process operations, elements and/or components, but do not exclude additional technical features, numerical values, method steps, process operations, elements, components, or any combination of the above.

Ordinal terms used in the claims, such as “first,” “second,” “third,” etc., are only for convenience of explanation, and do not imply any precedence relation between one another.

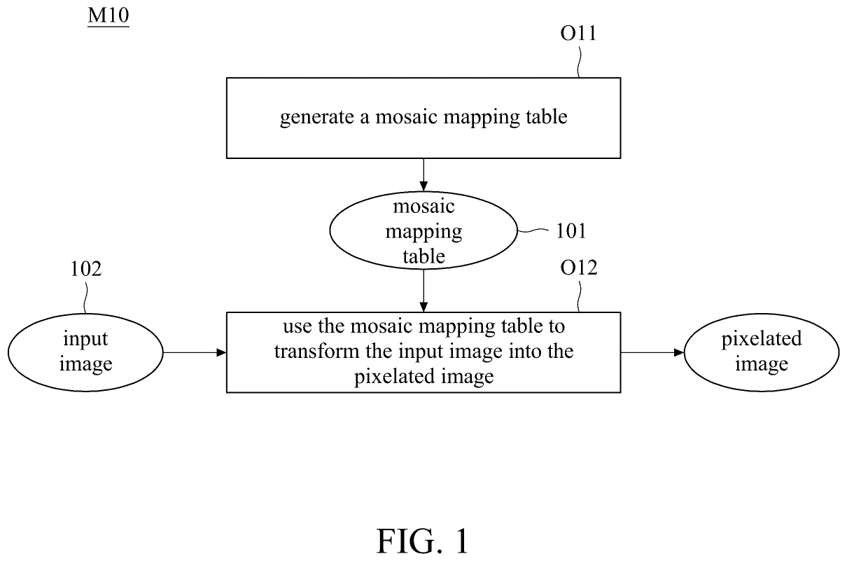

FIG. 1 is a flow diagram of a method M10 for image pixelization, according to an embodiment of the present disclosure. As shown in FIG. 1, method M10 includes a first operation O11 and a second operation O12. The first operation O11 involves generating a mosaic mapping table 101. The second operation O12 involves using the mosaic mapping table 101 to transform an input image 102 into a pixelated image 103.

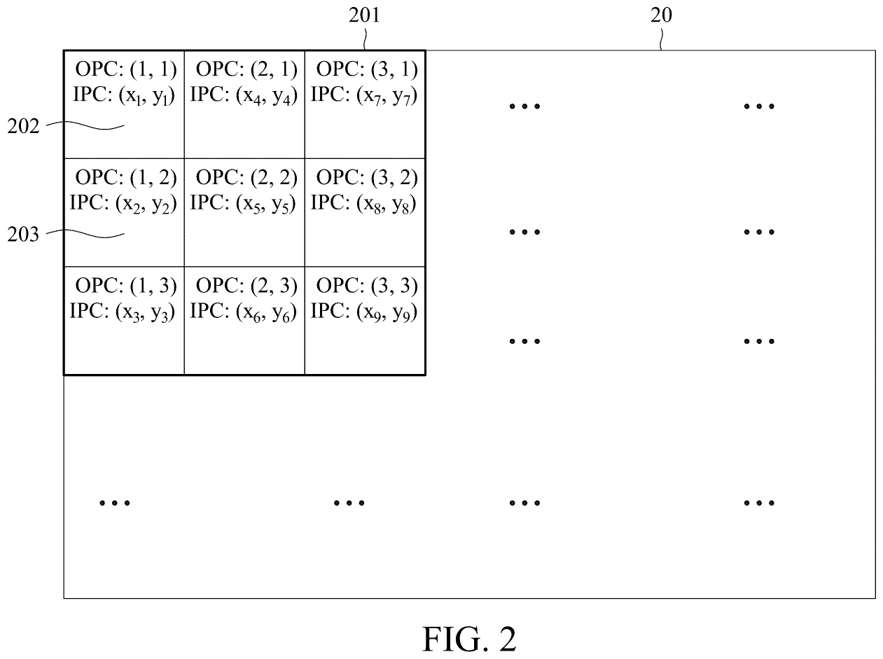

FIG. 2 shows an exemplary mosaic mapping table 20, according to an embodiment of the present disclosure. The mosaic mapping table 20 includes multiple mapping entries, such as the mapping entries 202 and 203 shown in FIG. 2. Each mapping entry records an output pixel coordinate (denoted as “OPC” in FIG. 2) of the pixelated image 103 and an input pixel coordinate (denoted as “IPC” in FIG. 2) of an input image 102. For example, the mapping entry 202 records the output pixel coordinate (1, 1) and the corresponding input pixel coordinate (x₁, y₁), the mapping entry 203 records the output pixel coordinate (1, 2) and the corresponding input pixel coordinate (x₂, y₂), and so on. In addition, the input pixel coordinate recorded in each mapping entry falls within a mosaic tile that includes the mapping entry. For example, the input pixel coordinate (x₁, y₁) recorded in the mapping entry 202, and the input pixel coordinate (x₂, y₂) recorded in the mapping entry 203, fall within the mosaic tile 201 that includes the mapping entries 202 and 203. Since the exemplary mosaic tile 201 has a 3×₃ coverage in pixel coordinates from (1, 1) to (3, 3), both input pixel coordinate (x₁, y₁) and input pixel coordinate (x₂, y₂) fall within the range of (1, 1) to (3, 3). This ensures that pixelated image 103 still retains, to some extent, the spatial coherence of input image 102.

In the second operation O12, the output pixel value corresponding to the output pixel coordinate recorded in each mapping entry is set to the input pixel value corresponding to the input pixel coordinate recorded in that mapping entry. For example, the output pixel value corresponding to the output pixel coordinate (1, 1) is set to the input pixel value corresponding to the input pixel coordinate (x₁, y₁), which is the pixel value of the input image 102 at the input pixel coordinate (x₁, y₁). Similarly, the output pixel value corresponding to the output pixel coordinate (1, 2) is set to the input pixel value corresponding to the input pixel coordinate (x₂, y₂), which is the pixel value of the input image 102 at the input pixel coordinate (x₂, y₂).

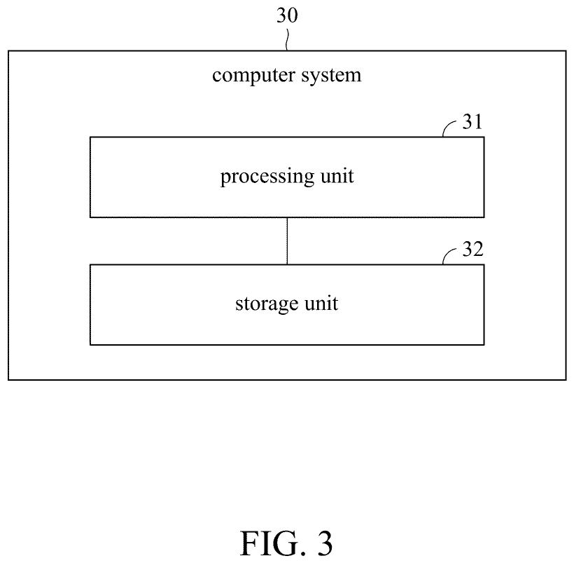

FIG. 3 is a block diagram of computer system 30 for image pixelization, according to an embodiment of the present disclosure. As shown in FIG. 3, the computer system 30 includes a processing unit 31 and a storage unit 32. The computer system 30 can be any device capable of executing computational tasks, such as a personal computer (including desktop computer, laptop computer, tablet computer, etc.), mobile computer (including mobile phone and mobile panel), or a server computer. The processing unit 31 may include one or more general-purpose processors such as central processing unit (CPU) and graphics processing unit (GPU), and/or a dedicated circuit such as application-specific integrated circuits (ASIC), field programmable gate arrays (FPGA) and/or system-on-chip (SoC). The storage unit 32 may include non-volatile memory such as Read-Only Memory (ROM), Electrically-Erasable Programmable Read-Only Memory (EEPROM), flash memory, Non-Volatile Random Access Memory (NVRAM), or any combination thereof. The storage unit 32 stores a program that includes instructions corresponding to the first operation O11 and the second operation O12 of the method M10. The program can be written in various programming languages, such as Python, C++, Java, and others, but the present disclosure is not limited thereto. In this embodiment, the processing unit 31 loads the program from the storage unit 32 to implement the method M10, including performing the first operation O11 and the second operation O12. The mosaic mapping table 101 generated by the first operation O11 can be stored in the storage unit 32 or other memory space such as dynamic random-access memory (DRAM) or static random-access memory (SRAM), but the present disclosure is not limited thereto.

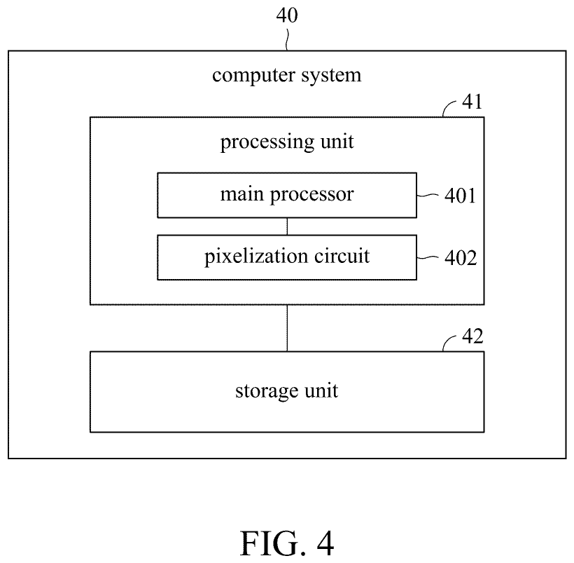

FIG. 4 is a block diagram of computer system 40 for image pixelization, according to another embodiment of the present disclosure. As shown in FIG. 4, the computer system 40 also includes a processing unit 41 and a storage unit 42. Similar to the computer system 40, the processing unit 41 also loads a program from the storage unit 42 to implement the method M10. However, unlike the computer system 30, the processing unit 41 further includes a main processor 401 and a pixelization circuit 402. The main processor 401 can be a general-purpose processor such as a central processing unit (CPU), a graphics processing unit (GPU), or a combination thereof, for performing the first operation O11. The pixelization circuit 402 can be implemented using application-specific integrated circuits (ASIC), field programmable gate arrays (FPGA), and/or system-on-chip (SoC), dedicated for performing the second operation O12. The mosaic mapping table 101 generated by the first operation O11 can be stored in the storage unit 32 or other memory space such as dynamic random-access memory (DRAM) or static random-access memory (SRAM), but the present disclosure is not limited thereto. In an alternative implementation, the mosaic mapping table 101 is stored into a buffer associated with the pixelization circuit 402. In response to the mosaic mapping table 101 being generated and stored into the buffer, the main processor 401 sends a start signal to the pixelization circuit 402 to trigger the second operation O12.

In various embodiments, the appearance of the pixelated image 103 can be influenced by three pixelization-related parameters: ROI parameter, mosaic type parameter, and a mosaic level parameter. The ROI parameter defines the ROI (region of interest) in the input image 102 to be pixelated. The mosaic type parameter defines the mosaic type of the pixelated image, in which different mosaic types presents different visual effects. The mosaic level parameter defines the tile size of the mosaic tiles. The larger the tile size of the mosaic tiles, the more pronounced the mosaic effect. These parameters can be either variables or hardcoded, but the present disclosure is not limited thereto.

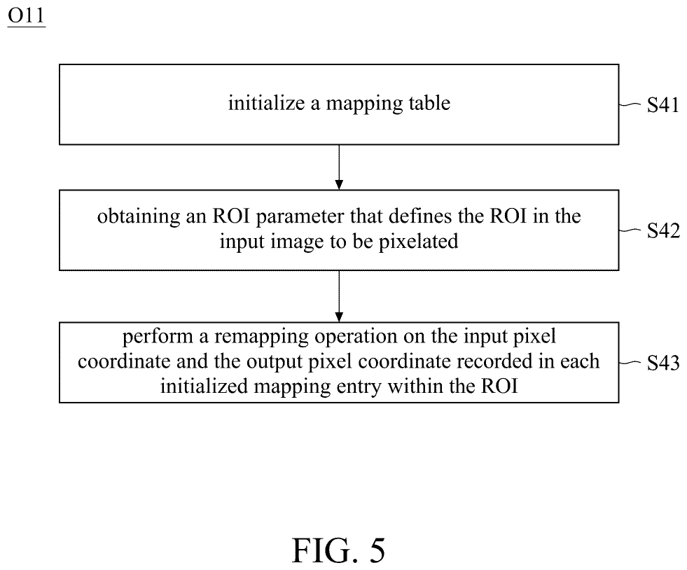

FIG. 5 is a flow diagram of detailed steps of the first operation O11, according to an embodiment of the present disclosure. As shown in FIG. 5, the first operation O11 can further include steps S41-S43.

In step S41, a mapping table is initialized. Each initialized mapping entry of the initialized mapping table records the output pixel coordinate, and the input pixel coordinate that is the same as the input pixel coordinate. For example, the output pixel coordinate (1, 3) should be mapped to the input pixel coordinate (1, 3) in an initialized mapping entry, and the output pixel coordinate (54, 95) should be mapped to the input pixel coordinate (54, 95) in another initialized mapping entry, and so on. If the initialized mapping table is directly applied in the transformation of input image 102, there would be no change to input image 102, because in the second operation O12, each output pixel would still take its pixel value from the corresponding position in input image 102. Therefore, to achieve a localized mosaic effect, subsequent steps S42 and S43 need to be performed.

In step S42, an ROI parameter that defines the ROI (region of interest) in the input image 102 to be pixelated, is obtained. The ROI can be rectangular, circular, or any arbitrary shape, but the present disclosure is not limited thereto. Additionally, the location and size of the ROI are also not limited by the present disclosure. In an implementation, the ROI parameter includes a location parameter, a size parameter, and a shape parameter, defining the location, size, and shape of the ROI, respectively. For example, when the shape parameter is set to a rectangle, indicating that the ROI is encompassed by a bounding box, the location parameter can be the coordinates of any vertex of the bounding box, and the size parameter can be the combination of the length and width of the bounding box. When the shape parameter is set to a circle, the location parameter can be the coordinates of the center, and the size parameter can be the radius or diameter of the circle.

In step S43, a remapping operation is performed on the input pixel coordinate and the output pixel coordinate recorded in each initialized mapping entry within the ROI. This remapping operation is performed on a mosaic tile-by-tile basis to generate the mosaic mapping table. Specifically, the remapping operation involves changing at least a portion of the input pixel coordinates recorded in each initialized mapping entry within each mosaic tile. Referring to the mapping entries 202 and 203 in FIG. 2 as an example, originally, the output pixel coordinates (1, 1) and (1, 2) in the initialized mapping entry are mapped to the same input pixel coordinates (1, 1) and (1, 2), respectively. In step S43, they are changed to map to (x₁, y₁) and (x₂, y₂), respectively. As mentioned earlier, although (x₁, y₁) and (x₂, y₂) may be different from the original (1, 1) and (1, 2), they still fall within mosaic tile 201. Therefore, the pixelated image 103 can exhibit a different appearance in the ROI compared to input image 102, yet it retains spatial coherence to some extent.

It should be further noted that, because areas outside the ROI have not undergone the remapping operation, the mapping entries in those areas will maintain the state where the input pixel coordinate equals the output pixel coordinate. Therefore, the pixelated image 103 will only exhibit mosaic effects within the ROI. Outside the ROI, there will be no mosaic effects.

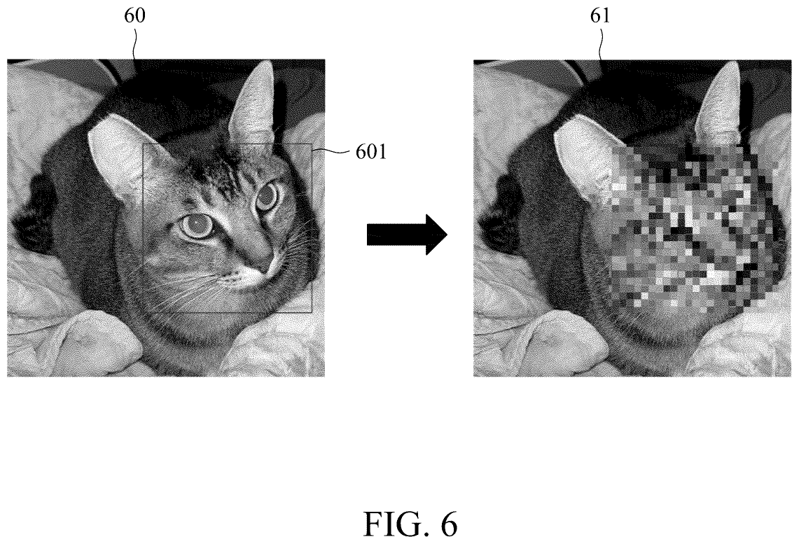

FIG. 6 showcases a comparison between an exemplary input image 60 and its corresponding pixelated image 61, according to an embodiment of the present disclosure. In FIG. 6, the exemplary input image 60 is a picture of a cat, where the head of the cat, identified by a bounding box, serves as the ROI 601. Following the transformation by the second operation O12, pixelated image 61 shows a mosaic effect specifically in the area corresponding to ROI 601, which is the cat's head. Areas outside the cat's head do not show any mosaic effect.

In an embodiment, the first operation O11 further involves obtaining a mosaic type parameter that defines a mosaic type of the pixelated image 103. Additionally, the remapping operation is performed based on the mosaic type parameter to generate the mosaic mapping table 101 that is used in the second operation O12 to transform the input image 102 into the pixelated image 103 with the mosaic type.

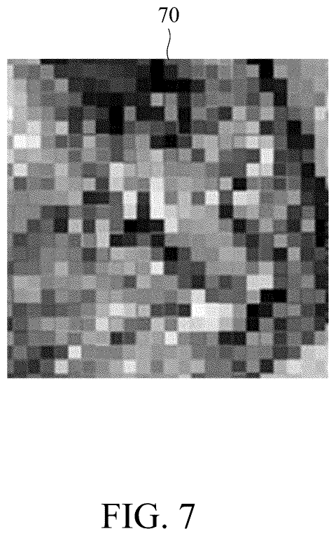

In a further embodiment, options of the mosaic type include a uniform-tile mosaic. In response to the mosaic type parameter being set to the uniform-tile mosaic, the remapping operation involves unifying the input pixel coordinates recorded in the initialized mapping entries within each mosaic tile to a specific pixel coordinate within that mosaic tile. Referring to FIG. 2 as an example, when the mosaic type is the uniform-tile mosaic, the input pixel coordinates (x₁, y₁), (x₂, y₂), . . . (x₉, y₉) recorded in all the mapping entries of mosaic tile 201 are unified to a specific pixel coordinate within mosaic tile 201, such as the center point (2, 2), or any one of (1, 1), (2, 1), (3, 1), (1, 2), (3, 2), (1, 3), (2, 3), (3, 3). FIG. 7 showcases an exemplary pixelated ROI 70 with the uniform-tile mosaic type, according to this embodiment. As shown in FIG. 7, each mosaic tile in the pixelated ROI 70 is of a uniform color, meaning that all the pixel values within each mosaic tile are the same.

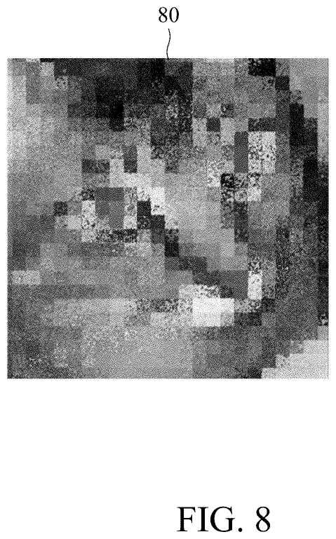

In another embodiment, options of the mosaic type include a randomized-pixel mosaic. In response to the mosaic type parameter being set to the randomized-pixel mosaic, the remapping operation includes randomly shuffling the input pixel coordinates recorded in the initialized mapping entries within each mosaic tile. Referring to FIG. 2 as an example, when the mosaic type is the randomized-pixel mosaic, each of the input pixel coordinates (x₁, y₁), (x₂, y₂), . . . (x₉, y₉) recorded in the mapping entries of mosaic tile 201 is randomly set to one of (1, 1), (2, 1), (3, 1), (1, 2), (2, 2), (3, 2), (1, 3), (2, 3), (3, 3), ensuring that no two input pixel coordinates are assigned the same coordinate value. FIG. 8 showcases an exemplary pixelated ROI 80 with the randomized-pixel mosaic type, according to this embodiment. As shown in FIG. 8, the pixels within each mosaic tile of the pixelated ROI 80 exhibit a randomized pattern, meaning that the pixel values within each tile are shuffled, creating a dispersed effect.

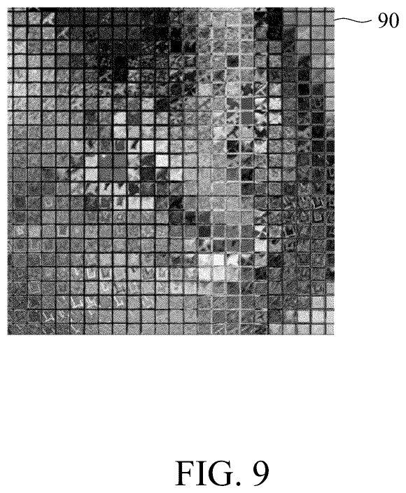

In yet another embodiment, options of the mosaic type include a chessboard mosaic. In response to the mosaic type parameter being set to the chessboard mosaic, the remapping operation includes unifying the input pixel coordinates recorded in the initialized mapping entries on borders of each mosaic tile to a specific pixel coordinate within that mosaic tile. Referring to FIG. 2 as an example, when the mosaic type is the chessboard mosaic, all mapping entries on the borders of mosaic tile 201 are unified to a specific pixel coordinate within mosaic tile 201, such as one of (1, 1), (2, 1), (3, 1), (1, 2), (2, 2), (3, 2), (1, 3), (2, 3), (3, 3). Given that the tile size of mosaic tile 201 is only 3×₃, except for the input pixel coordinate (x₅, y₅) recorded in the central mapping entry, all other input pixel coordinates recorded in the mapping entries are unified. FIG. 9 showcases an exemplary pixelated ROI 90 with the chessboard mosaic type, according to this embodiment. As shown in FIG. 9, the borders of each mosaic tile within the pixelated ROI 90 display a uniform pixel value, creating a distinctive border effect, while the interior pixels of each tile may retain varied pixel values, providing a unique visual appearance.

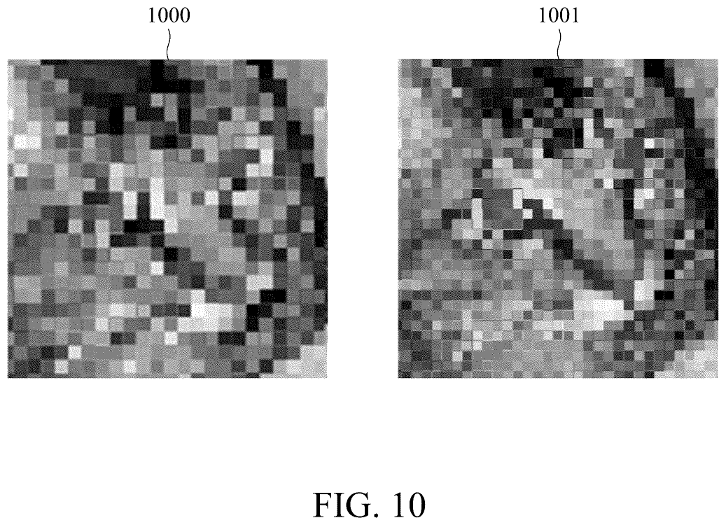

In an embodiment, the first operation O11 further involves obtaining a mosaic level parameter that defines the tile size of the mosaic tiles used in the remapping operation. The larger the tile size of the mosaic tiles, the more pronounced the mosaic effect. FIG. 10 showcases a comparison between an exemplary pixelated ROI 1000 and another exemplary pixelated ROI 1001, with the tile size being set to 20×20 and 15×15, respectively. As shown in FIG. 10, the pixelated ROI 1000 displays a more noticeable mosaic effect due to the larger tile size, resulting in more significant pixelation and less detail. In contrast, the pixelated ROI 1001, with a smaller tile size, displays a more subtle mosaic effect, preserving more details of the input image within the ROI.

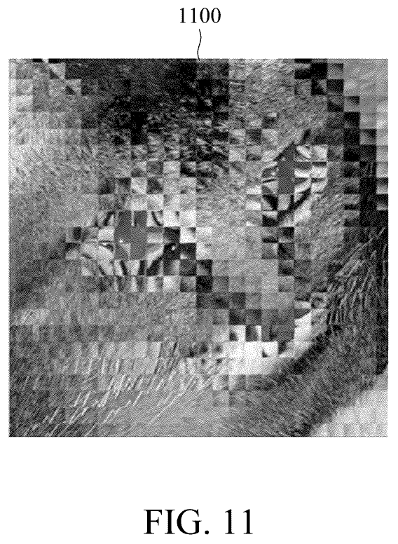

In an embodiment, the remapping operation further includes performing a geometric transformation on the input pixel coordinates recorded in each initialized mapping entry within each mosaic tile. The geometric transformation includes rotation, reflection, or a combination thereof. The rotation and/or reflection applied to the input pixel coordinates within the mosaic tiles of the mosaic mapping table will also be reflected in the pixelated image 103. FIG. 11 showcases an exemplary pixelated ROI 1100, in which the pixel values within each mosaic tile have undergone rotation and reflection. As shown in FIG. 11, the pixelated ROI 1100 displays a visually distinct pattern, demonstrating the effects of the geometric transformations on the appearance of the pixelated image.

In an embodiment, the ROI in the input image 102 to be pixelated is determined by performing object detection on the input image 102. For example, in the scenario of video conferencing, the ROI is typically the face of participants. Through object detection, a bounding box can be identified around each participant's face, which defines the ROI for pixelation. The bounding box specifies the location and size of the ROI, ensuring that the mosaic effect is applied accurately to the desired area. However, as previously mentioned, it should be appreciated that the ROI can be of any shape, such as a circle, or can be defined by instance segmentation of the participant's face. Additionally, in an embodiment where the processing unit includes a main processor and a pixelization circuit to perform the first operation O31 and the second operation O32 respectively, the object detection is also performed by the main processor.

In an embodiment, both the first operation O11 and the second operation O12 are performed in parallel. Specifically, while the second operation O12 is transforming a first frame of an input image sequence, the first operation O11 is generating the mosaic mapping table to be used for transforming a second frame subsequent to the first frame of the input image sequence. This embodiment is particularly suitable for real-time applications where the ROI varies with changes in the environment, such as in video conferencing. For example, the mosaic mapping table 101 may change as the number and/or positions of participants change.

The pixelization solution proposed in the present disclosure addresses the challenges of prior art from several aspects as described below. Firstly, in embodiments of the present disclosure, the realization of the mosaic effect is based on the mapping relationship between the pixel coordinates of the input image and the pixelated image, eliminating the need to calculate the average color value for each mosaic tile. Secondly, variations in the mosaic effects can be achieved by simply manipulating the mosaic mapping table to change the recorded pixel coordinates, without the need to compute pixel values for the R (red), G (green), and B (blue) channels. Furthermore, the transformation from the input image to the pixelated image can be performed by dedicated circuitry, without involving the GPU or CPU. This not only saves GPU and CPU resources but also leverages the real-time or near-real-time performance of dedicated circuits. In summary, the pixelization solution proposed in the present disclosure can achieve mosaic effects efficiently in real-time, reducing the burden on the CPU or GPU and freeing up computational resources for other tasks.

The above paragraphs are described with multiple aspects. Obviously, the teachings of the specification may be performed in multiple ways. Any specific structure or function disclosed in examples is only a representative situation. According to the teachings of the specification, it should be noted by those skilled in the art that any aspect disclosed may be performed individually, or that more than two aspects could be combined and performed.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for image pixelization, executed by a processing unit of a computer system, the method comprising:
a first operation, including generating a mosaic mapping table, wherein the mosaic mapping table comprises multiple mapping entries, each mapping entry recording an output pixel coordinate of a pixelated image and an input pixel coordinate of an input image, and wherein the input pixel coordinate falls within a mosaic tile that includes the mapping entry; and
a second operation, including using the mosaic mapping table to transform the input image into the pixelated image, wherein an output pixel value corresponding to the output pixel coordinate recorded in each mapping entry is set to an input pixel value corresponding to the input pixel coordinate recorded in that mapping entry.

2. The method as claimed in claim 1, wherein the first operation generates the mosaic mapping table by executing steps as follows:
initializing a mapping table, wherein each initialized mapping entry of the initialized mapping table records the output pixel coordinate, and the input pixel coordinate that is the same as the input pixel coordinate;
obtaining an ROI parameter that defines an ROI (region of interest) in the input image to be pixelated; and
performing a remapping operation on the input pixel coordinate and the output pixel coordinate recorded in each initialized mapping entry within the ROI;
wherein the remapping operation is performed on a mosaic tile-by-tile basis to generate the mosaic mapping table, and includes changing at least a portion of the input pixel coordinates recorded in each initialized mapping entry within each mosaic tile.

3. The method as claimed in claim 2, wherein the first operation further includes steps as follows to generate the mosaic mapping table:
obtaining a mosaic type parameter that defines a mosaic type of the pixelated image;
wherein the remapping operation is performed based on the mosaic type parameter to generate the mosaic mapping table that is used in the second operation to transform the input image into the pixelated image with the mosaic type.

4. The method as claimed in claim 3, wherein options of the mosaic type include a uniform-tile mosaic;
in response to the mosaic type parameter being set to the uniform-tile mosaic, the remapping operation includes unifying the input pixel coordinates recorded in the initialized mapping entries within each mosaic tile to a specific pixel coordinate within that mosaic tile.

5. The method as claimed in claim 3, wherein options of the mosaic type include a randomized-pixel mosaic;
in response to the mosaic type parameter being set to the randomized-pixel mosaic, the remapping operation includes randomly shuffling the input pixel coordinates recorded in the initialized mapping entries within each mosaic tile.

6. The method as claimed in claim 3, wherein options of the mosaic type include a chessboard mosaic;
in response to the mosaic type parameter being set to the chessboard mosaic, the remapping operation includes unifying the input pixel coordinates recorded in the initialized mapping entries on borders of each mosaic tile to a specific pixel coordinate within that mosaic tile.

7. The method as claimed in claim 2, wherein the first operation further includes steps as follows to generate the mosaic mapping table:
obtaining a mosaic level parameter that defines a tile size of the mosaic tiles used in the remapping operation.

8. The method as claimed in claim 2, wherein the ROI parameter includes a location parameter, a size parameter, and a shape parameter, defining location, size, and shape of the ROI, respectively.

9. The method as claimed in claim 1, wherein while the second operation is transforming a first frame of an input image sequence, the first operation is generating the mosaic mapping table to be used for transforming a second frame subsequent to the first frame of the input image sequence.

10. The method as claimed in claim 1, wherein the processing unit comprises a main processor and a pixelization circuit; and
wherein the first operation is performed by the main processor, and the second operation is performed by the pixelization circuit.

11. A computer system for image pixelization, comprising:
a storage unit, storing a program; and
a processing unit, loading the program from the storage unit to perform a first operation and a second operation;
wherein the first operation includes generating a mosaic mapping table, wherein the mosaic mapping table comprises multiple mapping entries, each mapping entry recording an output pixel coordinate of a pixelated image and an input pixel coordinate of an input image, and wherein the input pixel coordinate falls within a mosaic tile that includes the mapping entry; and
wherein the second operation includes using the mosaic mapping table to transform the input image into the pixelated image, wherein an output pixel value of the output pixel coordinate recorded in each mapping entry is set to an input pixel value corresponding to the input pixel coordinate recorded in that mapping entry.

12. The computer system as claimed in claim 11, wherein the processing unit generates the mosaic mapping table by executing steps as follows:
initializing a mapping table, wherein each initialized mapping entry of the initialized mapping table records the output pixel coordinate, and the input pixel coordinate that is the same as the input pixel coordinate;
obtaining an ROI (region of interest) parameter that defines an ROI in the input image to be pixelated; and
performing a remapping operation on the input pixel coordinate and the output pixel coordinate recorded in each initialized mapping entry within the ROI;
wherein the processing unit performs the remapping operation on a mosaic tile-by-tile basis to generate the mosaic mapping table, and the remapping operation includes changing at least a portion of the input pixel coordinates recorded in each initialized mapping entry within each mosaic tile.

13. The computer system as claimed in claim 12, wherein the processing unit further executes steps as follows to generate the mosaic mapping table:
obtaining a mosaic type parameter that defines a mosaic type of the pixelated image;
wherein the processing unit performs the remapping operation based on the mosaic type parameter to generate the mosaic mapping table that is used in the second operation to transform the input image into the pixelated image with the mosaic type.

14. The computer system as claimed in claim 13, wherein options of the mosaic type include a uniform-tile mosaic;
in response to the mosaic type parameter being set to the uniform-tile mosaic, the remapping operation includes unifying the input pixel coordinates recorded in the initialized mapping entries within each mosaic tile to a specific pixel coordinate within that mosaic tile.

15. The computer system as claimed in claim 13, wherein options of the mosaic type include a randomized-pixel mosaic;
in response to the mosaic type parameter being set to the randomized-pixel mosaic, the remapping operation includes randomly shuffling the input pixel coordinates recorded in the initialized mapping entries within each mosaic tile.

16. The computer system as claimed in claim 13, wherein options of the mosaic type include a chessboard mosaic;
in response to the mosaic type parameter being set to the chessboard mosaic, the remapping operation includes unifying the input pixel coordinates recorded in the initialized mapping entries on borders of each mosaic tile to a specific pixel coordinate within that mosaic tile.

17. The computer system as claimed in claim 12, wherein the processing unit further executes steps as follows to generate the mosaic mapping table:
obtaining a mosaic level parameter that defines a tile size of the mosaic tiles used in the remapping operation.

18. The computer system as claimed in claim 12, wherein the ROI parameter includes a location parameter, a size parameter, and a shape parameter, defining location, size, and shape of the ROI, respectively.

19. The computer system as claimed in claim 11, wherein while performing the second operation to transform a first frame of an input image sequence, the processing unit also performs the first operation to generate the mosaic mapping table to be used for transforming a second frame subsequent to the first frame of the input image sequence.

20. The computer system as claimed in claim 11, wherein the processing unit comprises:
a main processor, performing the first operation; and
a pixelization circuit, performing the second operation.
